(19) United States
(12) Patent Application Publication
(10) Pub. No.: US 2013/0063249 A1
(43) Pub. Date: Mar. 14, 2013

(54) EYEWASH WITH AUDIBLE DIRECTION INDICATION

(71) Applicant: Michel SHOFANI, Haifa (IL)

(72) Inventor: Michel SHOFANI, Haifa (IL)

(21) Appl. No.: 13/230,870

(22) Filed: Sep. 13, 2011

(51) Int. Cl. G08B 3/00

(52) U.S. Cl. 340/8.1

(57) ABSTRACT

System and method for giving an audible direction indication towards an eyewash. A first input device may receive a first indication from a user, the first indication suggesting that the eyewash is needed. An audio device may generate an audio signal, upon the receiving of the first indication, the audio signal indicative of the location of the eyewash.

### BACKGROUND OF THE INVENTION

Eyewashes and safety showers are emergency systems used as first aid to prevent or minimize injury in case of contact with hazardous substances. Eyewashes are typically designed to irrigate and flush the eyes by ejecting a liquid stream towards both eyes. Eyewash stations are typically installed not far from working stations that may include hazardous substances.

In case of contamination of the eyes, timing of treatment is of critical importance. Some chemicals can penetrate the cornea within less than ten seconds and may cause severe injury or blindness. Therefore, it is extremely important to flush the chemical out of the eyes immediately. Delaying treatment, even for a few seconds, may cause severe injury.

In the past, work assignments involving hazardous substances used to be performed by a team. Hence, in case of an injury, fellow workers could help the injured person and guide him or her to the eyewash Currently, however, due to technological improvements and automation of many processes, a lot less employees are typically needed. In many working environments it is not rare to find a single employee working in substantially remote or isolated working stations.

To help personnel reach the eyewash station quickly after contamination, the eyewashes and/or safety shower stations are typically instilled near the working station that may include hazardous substances. In addition the pathways to the eyewashes and/or safety shower stations should be kept free of abstractions and the eyewashes and/or safety shower stations are typically marked with highly visible sign.

However, in case of chemical eye injury, the eyelids are usually shut. The affected person may, thus, become disoriented and unable to see the signs showing where the eyewash station is located, regardless of whichever clear and highly visible markings of the eyewashes and/or safety shower stations.

### SUMMARY OF THE INVENTION

According to embodiments of the present invention there is provided a method for giving an audible direction indication towards an eyewash The method may include receiving a first indication from a user, the first indication suggesting that the eyewash is needed; and activating an audio signal, upon the receiving of the first indication, the audio signal indicative of the location of the eyewash.

Furthermore, according to embodiments of the present invention, the method may include activating the eyewash upon the receiving of the first indication.

Furthermore, according to embodiments of the present invention, the first indication may be vocal or verbal.

Furthermore, according to embodiments of the present invention, the method may include performing speech processing to analyze the content of the first indication.

Furthermore, according to embodiments of the present invention, the indication may be received using a microphone.

Furthermore, according to embodiments of the present invention, the microphone may be placed within a predetermined distance from a workstation.

Furthermore, according to embodiments of the present invention, the first indication may be received via an input device selected from a group of input devices including a button, a switch and a touch screen.

Furthermore, according to embodiments of the present invention, the method may include receiving a second indication from the user, the second indication suggesting that the user has reached the eyewash; and activating the eyewash upon receiving of the second indication.

Furthermore, according to embodiments of the present invention, the second indication may be received by a sensor.

Furthermore, according to embodiments of the present invention, a source of the audio signal may be within a predetermined distance from the eyewash.

Furthermore, according to embodiments of the present invention, there is provided a system for giving an audible direction indication towards an eyewash. The system may include a first input device to receive a first indication from a user, the first indication suggesting that the eyewash is needed; and an audio device to generate an audio signal, upon the receiving of the first indication, the audio signal indicative of the location of the eyewash.

Furthermore, according to embodiments of the present invention, the system may include a control module to activate the eyewash upon the receiving of the first indication.

Furthermore, according to embodiments of the present invention, the system may include

Furthermore, according to embodiments of the present invention, the first input device may be designed to receive a second indication from the user, the second indication suggesting that the user has reached the eyewash, and the system may include a control module to activate the eyewash upon receiving of the second indication.

Furthermore, according to embodiments of the present invention, the system may include a second input device to receive a second indication from the user, the second indication suggesting that the user has reached the eyewash; and a control module to activate the eyewash upon receiving of the second indication.

Furthermore, according to embodiments of the present invention, the system may include a sensor to sense that the user is within a determined distance from the eyewash and a control module to activate the eyewash upon sensing of the user.

Furthermore, according to embodiments of the present invention, the input device may be designed to receive the first indication in the form of a vocal or verbal indication.

Furthermore, according to embodiments of the present invention, the system may include a speech processing module to analyze the content of the first indication.

Furthermore, according to embodiments of the present invention, the first input device may include a microphone.

Furthermore, according to embodiments of the present invention, the first input device may be selected from a group including a button, a switch and a touch screen.

Furthermore, according to embodiments of the present invention, the audio device may be placed proximal to the eyewash

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a flowchart illustration of a method for giving a direction indication towards an eyewash according to embodiments of the present invention;

FIG. 2 is a high-level diagram of an exemplary eyewash with an audible direction indication system according to embodiments of the present invention;

FIG. 3 is a high-level diagram of another exemplary eyewash with an audible direction indication system according to embodiments of the present invention;

FIG. 4 is a high-level diagram of another exemplary eyewash with an audible direction indication system according to embodiments of the present invention;

FIG. 5 is a high-level diagram of another exemplary eyewash with an audible direction indication system according to embodiments of the present invention; and

FIG. 6 is a high-level diagram of an exemplary eyewash with an audible direction indication according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

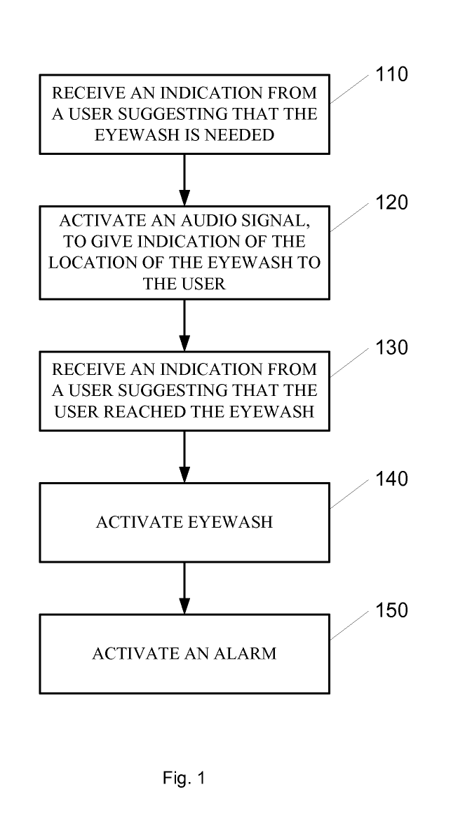

Reference is now made to FIG. 1 which is a flowchart illustration of a method for giving a direction indication towards an eyewash according to embodiments of the present invention. According to embodiments of the present invention, a distress call suggesting that the eyewash is needed may be received 110 from a user. For example, the distress call may be vocal, e.g. the distress call may be verbal. For example, a user may say in regular voice, say in a loud voice or call out a predetermined word or phrase when in need of an eyewash. According to some embodiments of the present invention, an input device may receive the indication. For example, an input device may receive audio signals from the environment, perform speech processing to analyze the audio signals, and recognize the predetermined word or phrase. Such input device may include a microphone and a speech processing module. The microphone may be placed close enough to the workstation or the user so that the distress call may be clearly received. The exact limitation may depend on the sensitivity of the microphone and the speech processing algorithm, as well as on environmental conditions such as the background noise.

Additionally or alternatively, the input device may be an electro mechanical input device. The user may activate the electro mechanical input device by pressing a button, activating a switch or touching a touch screen placed in a convenient and well known location with relation to the user. For example, the button, switch or touch screen may be located in a known location within the workstation or near the work station. For example, the electro mechanical input device may be placed in a distance of up to 1 meter from the workstation. Alternatively, the button, switch or touch screen may be handheld devices carried by the user. For example, such handheld devices may be placed in the user's pocket or worn as a watch.

In case a distress call is received from a user, suggesting that the eyewash is needed, an audio signal may be generated 120, the audio signal indicative of the location of the eyewash. For example, if the distress call is vocal, the predetermined word or phrase may be recognized, additionally or alternatively, the button may be pressed, the switch may be activated or the touch screen may be touched. The audio signal may be generated by, for example a loudspeaker, a siren, a buzzer, or any other device capable of generating sounds, located proximal to the eyewash The source of the audio signal may be placed proximal to the eyewash so that the sound generated by the audio source may sound as if it was originated from the same or substantially the same location of the eyewash. For example, the source of the audio signal may be embedded within the eyewash, attached to the eyewash or placed within a distance of up to 2 meters from the eyewash.

The audio signal may be generated to give the user an audible direction indication towards the eyewash. In case of contamination of the eyes, the eyes of the user may typically be closed and the user may not see his/hers way to the eyewash However, according to embodiments of the present invention, the user may hear the audio signal, recognise the general direction of the source of the audio signal, which may be the general direction to the eyewash, and move towards that direction.

Optionally, a second indication may be received from the user 130, the second indication suggesting that the user has reached the eyewash. The second indication may be referred to as reached eyewash indication throughout the application. The reached eyewash indication may be vocal, e.g. the reached eyewash indication may be verbal. For example, the user may say in a normal voice, say in a loud voice or call out a second predetermined word or phrase. An input device, either the input device used for the first indication or a second input device, may receive audio signals from the environment, perform speech processing to analyze the audio signals, and recognize the second predetermined word or phrase. Additionally or alternatively, the user may press a button, activate a switch or touch a touch screen placed in a convenient and well known location with relation to the eyewash or the user. For example, the button, switch or touch screen may be located in a known location within the eyewash or near the eyewash. Alternatively, the button, switch or touch screen may be the handheld devices carried by the user. Additionally or alternatively a sensor may sense that a user is within a determined distance from the eyewash and generate the reached eyewash indication. For example, the sensor may sense an object (e.g. the head of the user) in proximity to the eyewash (e.g. within a distance of up to 2 meters from the eyewash). For example, an Infrared sensor, a volume sensor, a camera, a scale or any other suitable sensor may sense that a user is near the eyewash. Upon receiving of the reached eyewash indication, or upon sensing of the user by the sensor, the eyewash may be activated, 140. Alternatively, the eyewash may be activated upon receiving of the distress call. Upon receiving of the distress call, or upon activating the eyewash, an alarm may be activated 150. The alarm may be audible or visual or both The alarm may indicate that a worker was exposed to hazardous substances and is in need of immediate help and medical attention. The alarm may be activated in a control room or in locations that are occupied most of the time by other personnel. In addition, an alarm may be activated in a medical facility, a nearby clinic or hospital for calling medical assistance.

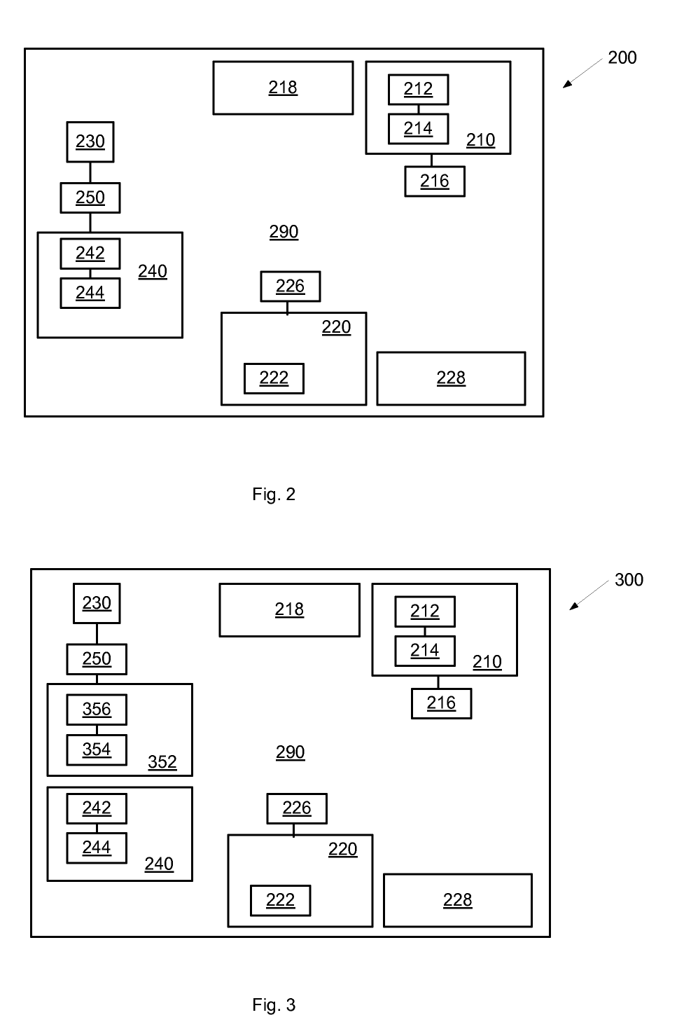

Reference is made to FIG. 2 which is a high-level diagram of an exemplary eyewash with an audible direction indication system 200 according to embodiments of the present invention. According to embodiments of the present invention, system 200 may include an input device 210 to receive the distress call from a user, the distress call suggesting that the eyewash is needed. For example, input device 210 may be designed to receive the distress call in the form of a vocal indication. For example, input device 210 may include a microphone 212 and a speech processing module 214. In case the eyes of a user are contaminated, the user may say a predetermined word or phrase. Microphone 212 may receive audio signals from the environment, convert the audio signals into electrical or digital signals and transfer these signals to a speech processing module 214. Speech processing module 214 may analyze the content of the audio signals and may recognize the predetermined word or phrase. In case the predetermined word or phrase is recognized, a signal may be sent by transmitter 216 to a receiver 242 to suggesting that a distress call was received from the user. Input device 210 may be located close to a workstation 218, or may be embedded within workstation 218, such that microphone 212 may be sensitive enough to receive voices of users working in workstation 218 in sufficient quality such that speech processing module 214 may be able to analyze the audio signals and recognize the predetermined word or phrase. Additionally or alternatively, input device 220 may include an electromechanical device 222 such as a button, a switch or a touch screen. In case the eyes of a user are contaminated, the user may activate electromechanical device 222. In case electromechanical device 222 is activated, a signal may be sent by transmitter 226 to audio device 240. Input device 220 may be located in a known location within workstation 228 or near workstation 228. Alternatively, input device 220 may be a handheld device carried by the user. For example, such handheld devices may be placed in the user's pocket or worn as a watch

System 200 may be located in a working environment 290 which may be a factory, a laboratory or any other facility in which users may be in contact with hazardous materials. Input units 210 and 220, and audio device 240 may be located in the same room or in separate rooms.

It should be noted that both input devices 210 and 220 may be used concurrently, in any suitable arrangement. For example, microphone 212 may be placed near a workstation or in a central location within working environment 290, while each user may carry an input device 220. When used concurrently, input devices 210 and 220 may each be connected to a dedicated transmitter, for example, transmitters 216 and 226, or both input devices 210 and 220 may share a transmitter, for example, transmitters 216.

According to embodiments of the present invention, system 200 may include an audio device 240. Audio device 240 may generate an audio signal, upon the receiving of the distress call, the audio signal indicative of the location of eyewash 230. Audio device 240 may include a receiver 242 to receive signals from input devices 210 and 220, and a sound generating device 244 to generate the audio signal. Sound generating device 244 may include loudspeaker, a siren, a buzzer, or any other element capable of generating sounds. Audio device 240 may located within proximal to eyewash 230.

Transmitters 216 and 226 may communicate with receiver 242 in any applicable wired or wireless, known or propriety communication protocol, such as Bluetooth, Wi-Fi, infrared communication, local area networking (LAN) etc.

According to embodiments of the present invention system 200 may also include a control module 250. Control module 250 may activate eyewash 230 upon receiving of the distress call.

Reference is made to FIG. 3 which is a high-level diagram of another exemplary eyewash with an audible direction indication system 300 according to embodiments of the present invention. System 300 may be similar to system 200, however, system 300 may include an eyewash input device 352. Eyewash input device 352 may receive the reached eyewash indication from the user, the reached eyewash indication suggesting that the user has reached eyewash 230. Control module 250 may activate eyewash 230 upon receiving of the reached eyewash indication.

The reached eyewash indication may be vocal. For example, the user may say a second predetermined word or phrase. Eyewash input device 352 may include a microphone 354 and a speech recognition module 356. Microphone 354 may receive audio signals from the environment, convert the audio signals to electrical or digital signals and transfer them to speech recognition module 356. Speech recognition module 356 may perform speech processing to analyze the audio signals, and recognize the second predetermined word or phrase. Input device 352 may be located, for example, near eyewash 230 or may be embedded within eyewash 230.

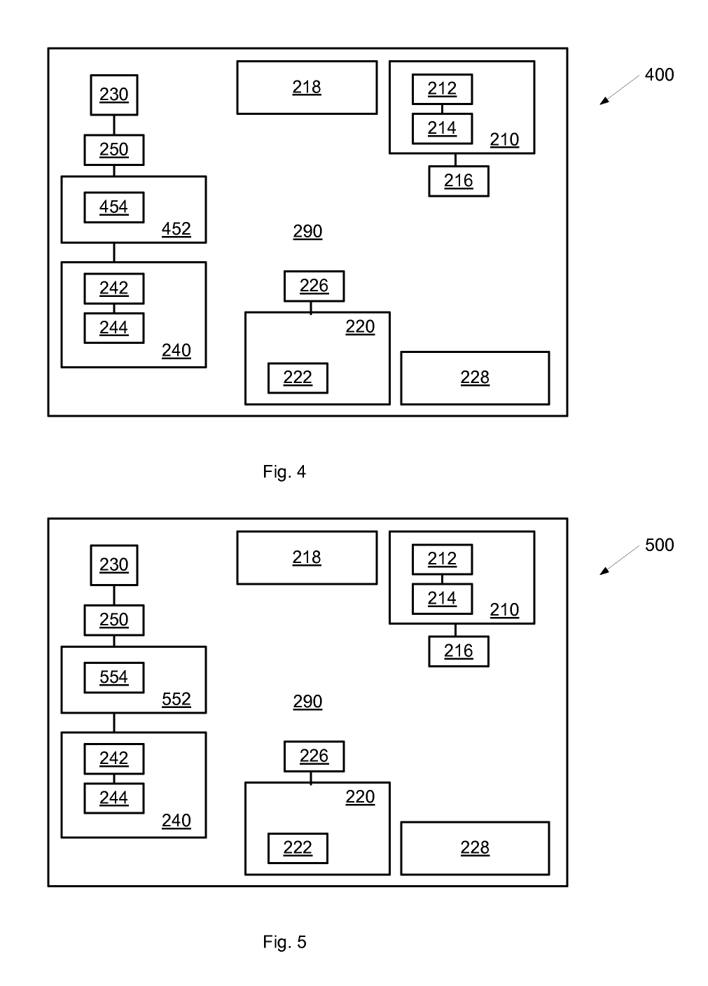

Reference is made to FIG. 4 which is a high-level diagram of another exemplary eyewash with an audible direction indication system 400 according to embodiments of the present invention. System 400 may be similar to system 200, however, system 400 may include an eyewash input device 452. Eyewash input device 452 may receive the reached eyewash indication from the user, the reached eyewash indication suggesting that the user has reached eyewash 230. Control module 250 may activate eyewash 230 upon receiving of the reached eyewash indication.

Input device 452 may include an electromechanical device 454, e.g., a button, a switch or a touch screen placed in a convenient and well known location with relation to eyewash 230 or the user. For example, input device 452 may be located in a known location within eyewash 230 or near eyewash 230. Alternatively, electromechanical device 454 may be handheld device carried by the user. In case the user has reached eyewash 230, the user may activate electromechanical device 454 by, for example, by pushing a button, changing the state of a switch or touching the touch screen. In case electromechanical device 454 is a handheld device, electromechanical device 454 may be used to receive both the distress call and the reached eyewash indication.

Reference is made to FIG. 5 which is a high-level diagram of another exemplary eyewash with an audible direction indication system 500 according to embodiments of the present invention. System 500 may be similar to system 200, however, system 500 may include an eyewash input device 552. Eyewash input device 552 may receive the reached eyewash indication from the user, the reached eyewash indication suggesting that the user has reached eyewash 230. Control module 250 may activate eyewash 230 upon receiving of the reached eyewash indication.

Eyewash input device 552 may include a sensor 554 to sense that a user is near the eyewash and generate the reached eyewash indication. For example, an Infrared sensor, a volume sensor, a camera, a scale or any other suitable sensor may sense that a user is near eyewash 230. Control module 250 may activate eyewash 230 upon sensing of the user by sensor 554.

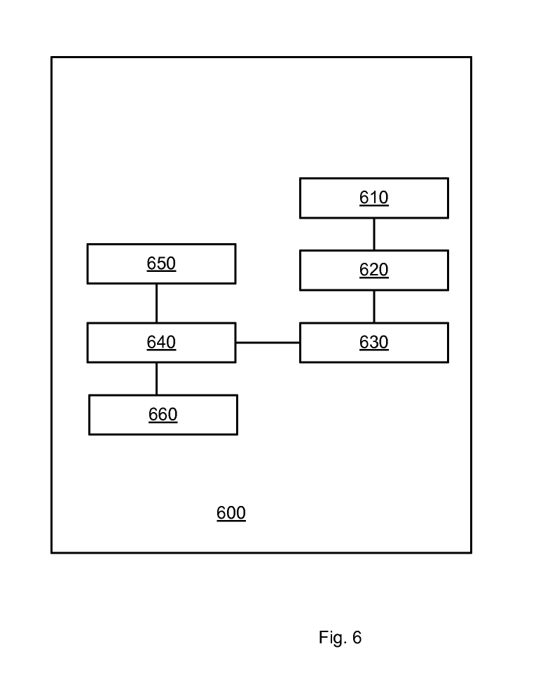

Reference is made to FIG. 6 which is a high-level diagram of an exemplary eyewash with an audible direction indication 600 according to embodiments of the present invention. According to embodiments of the present invention eyewash 600 may include a microphone 610. In case the eyes of a user are contaminated, the user may say a predetermined word or phrase. Microphone 610 may receive audio signals from the environment, convert the audio signals into electrical or digital signals and transfer these signals to a speech processing module 620. Speech processing module 620 may analyze the content of the audio signals and may recognize the predetermined word or phrase suggesting that an distress call was received from the user. Upon the receiving of the distress call, a sound generating device 630 may generate an audio signal, the audio signal indicative of the location of eyewash 600. Sound generating device 630 may include a loudspeaker, a siren, a buzzer, or any other element capable of generating sounds. Optionally, eyewash 600 may include a control module 640. Control module 640 may activate eyewash 230 upon receiving of the distress call. Alternatively, control module 640 may activate eyewash 230 upon receiving of a reached eyewash indication. The reached eyewash indication may be vocal, for example, a second word or phrase said by the used, received by microphone 610 and recognized by speech processing module 620. Additionally or alternatively, eyewash 600 may include an electromechanical device 650, e.g., a button, a switch or a touch screen placed in a convenient and well known location with relation to eyewash 600. The user may activate electromechanical device 640 when close to eyewash 600 to generate the reached eyewash indication and activate eyewash 600. Additionally or alternatively, eyewash 600 may include a sensor 660, to sense that a user is near eyewash 600 and generate the reached eyewash indication. Control module 640 may activate eyewash 230 upon sensing of the user by sensor 660.

While a specific set of modules (input devices, speech processing modules, etc.) are described, the functionality described herein may be carried out by other combinations of modules.

Some embodiments of the present invention may be implemented in software for execution by a processor-based system, for example, speech processing module 214 and control module 640. For example, embodiments of the present invention may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for giving an audible direction indication towards an eyewash, the method comprising:
receiving a first indication from a user, the first indication suggesting that the eyewash is needed; and
activating an audio signal, upon the receiving of the first indication, the audio signal indicative of the location of the eyewash.

2. The method of claim 1, comprising activating the eyewash upon the receiving of the first indication.

3. The method of claim 1, wherein the first indication is vocal or verbal.

4. The method of claim 3, comprising:
performing speech processing to analyze the content of the first indication.

5. The method of claim 3, wherein the indication is received using a microphone.

6. The method of claim 5, wherein the microphone is placed within a predetermined distance from a workstation.

7. The method of claim 1, wherein the first indication is received via an input device selected from a group of input devices consisting of a button, a switch and a touch screen.

8. The method of claim 1, further comprising:
receiving a second indication from the user, the second indication suggesting that the user has reached the eyewash; and
activating the eyewash upon receiving of the second indication.

9. The method of claim 8 wherein the second indication received by a sensor.

10. The method of claim 1, wherein a source of the audio signal is within a predetermined distance from the eyewash.

11. A system for giving an audible direction indication towards an eyewash, the system comprising:
a first input device to receive a first indication from a user, the first indication suggesting that the eyewash is needed; and
an audio device to generate an audio signal, upon the receiving of the first indication, the audio signal indicative of the location of the eyewash.

12. The system of claim 11, comprising a control module to activate the eyewash upon the receiving of the first indication.

13. The system of claim 11, wherein the first input device is designed to receive a second indication from the user, the second indication suggesting that the user has reached the eyewash, the system further comprising a control module to activate the eyewash upon receiving of the second indication.

14. The system of claim 11, further comprising:
a second input device to receive a second indication from the user, the second indication suggesting that the user has reached the eyewash; and
a control module to activate the eyewash upon receiving of the second indication.

15. The system of claim 11, further comprising:
a sensor to sense that the user is within a determined distance from the eyewash; and
a control module to activate the eyewash upon sensing of the user.

16. The system of claim 11, wherein the input device is designed to receive the first indication in the form of a vocal or verbal indication.

17. The system of claim 16, comprising:
a speech processing module to analyze the content of the first indication.

18. The system of claim 16, wherein the first input device comprises a microphone.

19. The system of claim 11, wherein the first input device is selected from a group consisting of a button, a switch and a touch screen.

20. The system of claim 11, wherein the audio device is placed proximal to the eyewash.
